(19) United States
(12) Patent Application Publication
(10) Pub. No.: US 2023/0127807 A1
(43) Pub. Date: Apr. 27, 2023

(54) VALVE INCLUDING AN AXIALLY SHIFTABLE AND ROTATIONALLY LOCKABLE VALVE SEAT

(71) Applicant: Baker Hughes Oilfield Operations LLC, Houston, TX (US)

(72) Inventor: Dennis G. Jiral, Katy, TX (US)

(21) Appl. No.: 17/965,890

(22) Filed: Oct. 14, 2022

Related U.S. Application Data
(60) Provisional application No. 63/270,270, filed on Oct. 21, 2021.

(51) Int. Cl. E21B 34/14; F16K 1/42

(52) U.S. Cl. CPC E21B 34/14; F16K 1/427; E21B 2200/06

(57) ABSTRACT

A wellbore tool includes a housing including a wall having an outer surface and an inner surface defining a passage. The housing has an outlet extending through the wall. A valve sleeve is axially slidably arranged in the passage. The valve sleeve includes a wall portion including a first end, a second end, an outer surface portion, an inner surface portion, an outlet portion that selectively aligns with the outlet in the housing. A locking mechanism is provided on the valve sleeve. A valve seat is axially slidably arranged at the first end of the valve sleeve. The valve seat being selectively rotationally locked to the valve sleeve by the locking mechanism.

### CROSS-REFERENCE TO RELATED APPLICATIONS

This application claims the benefit of U.S. Provisional Patent Application No. 63/270,270, filed Oct. 21, 2021, the contents of which are incorporated by reference herein in their entirety.

### BACKGROUND

In the resource recovery industry, two and three stage cementing operations are often needed to form a wellbore liner. In, for example, a two-stage cementing operation, cement is passed through a tubular string to a toe of a wellbore. The cement flows upwardly along a void that exists between a wellbore wall and an outer surface of the tubular string. If the pressure needed to flow the cement upward exceeds a selected level, a valve may be opened along the tubular string. Cement is passed through the valve and downward to unite with the cement that flowed upward.

To open the valve, a tool is landed on a valve seat and pressure is applied. The pressure shifts the valve open. Once complete, a closing device is pumped to an upper valve seat and additional pressure is applied to close the valve. A drill is introduced into the wellbore to drill through the valve and reopen a flow path to the tow. Occasionally, while drilling, an inner assembly of the valve may rotate with the drill. In such cases, removing the valve and opening the flow path can be difficult. Accordingly, the industry would welcome a valve that includes an anti-rotation feature.

### SUMMARY

Disclosed, in accordance with a non-limiting example, is a wellbore tool including a housing including a wall having an outer surface and an inner surface defining a passage. The housing has an outlet extending through the wall. A valve sleeve is axially slidably arranged in the passage. The valve sleeve includes a wall portion including a first end, a second end, an outer surface portion, an inner surface portion, an outlet portion that selectively aligns with the outlet in the housing. A locking mechanism is provided on the valve sleeve. A valve seat is axially slidably arranged at the first end of the valve sleeve. The valve seat being selectively rotationally locked to the valve sleeve by the locking mechanism.

Also disclosed, in accordance with a non-limiting example, is a resource exploration and recovery system including a surface system, a subsurface system, and a tubular string extending from the surface system into the subsurface system. The tubular string supports a wellbore tool including a housing including a wall having an outer surface and an inner surface defining a passage. The housing has an outlet extending through the wall. A valve sleeve is axially slidably arranged in the passage. The valve sleeve includes a wall portion including a first end, a second end, an outer surface portion, an inner surface portion, an outlet portion that selectively aligns with the outlet in the housing. A locking mechanism is provided on the valve sleeve. A valve seat is axially slidably arranged at the first end of the valve sleeve. The valve seat being selectively rotationally locked to the valve sleeve by the locking mechanism.

### BRIEF DESCRIPTION OF THE DRAWINGS

The following descriptions should not be considered limiting in any way. With reference to the accompanying drawings, like elements are numbered alike:

FIG. 1 depicts a resource exploration and recovery system including a valve having an axially slidable and rotationally lockable valve seat, in accordance with a non-limiting example;

FIG. 2 depicts the valve of FIG. 1, in a run-in-hole configuration, in accordance with a non-limiting example;

FIG. 3 depicts the valve of FIG. 2 in an open or cementing configuration, in accordance with a non-limiting example;

FIG. 4 depicts the valve of FIG. 3 in a closed configuration following a cementing operation, in accordance with a non-limiting example; and

FIG. 5 depicts the valve of FIG. 1 moving directly from a run-in-hole configuration to a closed configuration, in accordance with a non-limiting example.

### DETAILED DESCRIPTION

A detailed description of one or more embodiments of the disclosed apparatus and method are presented herein by way of exemplification and not limitation with reference to the Figures.

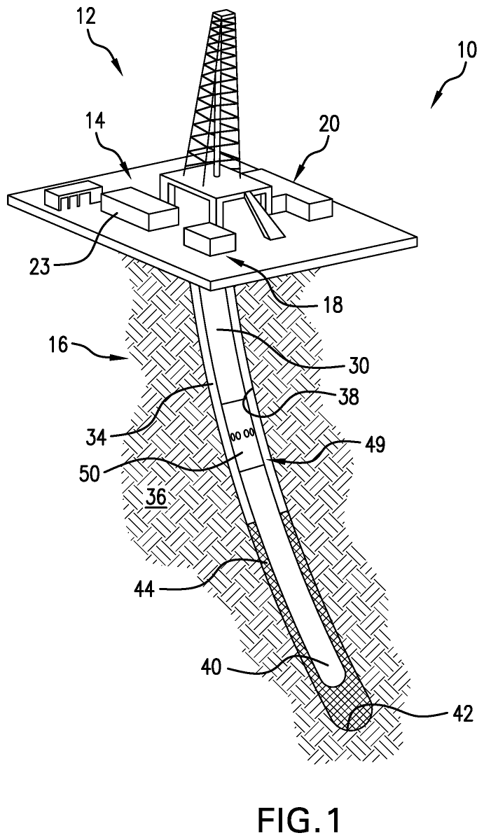

A resource exploration and recovery system, in accordance with an exemplary embodiment, is indicated generally at 10, in FIG. 1. Resource exploration and recovery system 10 should be understood to include well drilling operations, resource extraction and recovery, CO₂ sequestration, and the like. Resource exploration and recovery system 10 may include a first system 12 which, in some environments, may take the form of a surface system 14 operatively and fluidically connected to a second system 16 which, in some environments, may take the form of a subsurface system.

First system 12 may include pumps 18 that aid in completion and/or extraction processes as well as fluid storage 20. Fluid storage 20 may contain a stimulation fluid which may be introduced into second system 16. First system 12 may also include a control system 23 that may monitor and/or activate one or more downhole operations. Second system 16 may include a tubular string 30 formed from a plurality of tubulars (not separately labeled) that is extended into a wellbore 34 formed in formation 36. Wellbore 34 includes an annular wall 38 that may be defined by a surface of formation 36. Tubular string 30 may terminate at a float shoe 40 that is extended towards a toe 42 of wellbore 34. A cement liner 44 may be formed between tubular string 30 and annular wall 38.

In a non-limiting example, tubular string 30 supports a wellbore tool 49 that takes the form of a cementing tool or valve 50. Cementing valve 50 introduces cement from a section of tubular string above toe 42 to continue or complete a liner forming operation. That is, if the pressure needed to pump cement uphole exceeds a selected threshold, cement may be introduced through cementing valve 50.

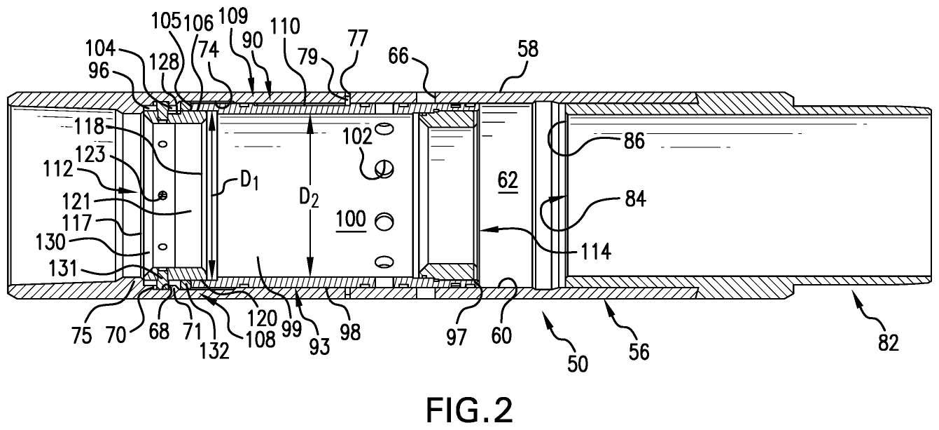

Reference will now follow to FIGS. 2-4 in describing cementing valve 50 in accordance with a non-limiting example. Cementing valve 50 includes a housing 56 having an outer surface 58 and an inner surface 60 that defines a passage 62. A plurality of outlets 66 extend through housing 56 and provide a pathway for cement to pass into wellbore 34. An annular groove 68 is formed on inner surface 60. In a non-limiting example, annular groove 68 is defined between a first raised rib 70 and a second raised rib 74. An annular recess 74 is formed in inner surface 60 adjacent to second raised rib 74. A travel stop 75 is arrange adjacent to first raised rib 70. A pin opening 77 is formed in housing 56. A pin 79 is inserted into pin opening 77 and extends into passage 62 as will be detailed herein. In a non-limiting example, a tubular member 82 is fixedly mounted in passage 62 and includes an axial end surface 84 that forms a travel limiter 86.

In a non-limiting example, cementing valve 50 includes a valve sleeve 90 that is shiftably mounted in passage 62. Valve sleeve 90 may slide in passage 62 between travel stop 75 and travel limiter 86. Valve sleeve 90 includes a wall portion 93 having a first end 96 and a second end 97. Wall portion 93 also includes an outer surface portion 98 and an inner surface portion 99 that extend between first end 96 and second end 97. Inner surface portion 99 defines a passage portion 100. A plurality of outlet portions 102 extend through wall portion 93. Outlet portions s 102 selectively align with outlets 66.

In a non-limiting example, valve sleeve 90 also includes a first plurality of opening portions 104 arranged adjacent to first end 96 and a second plurality of opening portions 105 arranged adjacent to first plurality of opening portions 104. A valve seat receiver 106 is formed in inner surface portion 99 at first end 96. Valve seat receiver 106 includes a first diameter D1 and passage portion 100 includes a second diameter D2 that is less than the first diameter D1.

In a non-limiting example, valve sleeve 90 also includes a locking mechanism 108 having an anti-rotation feature 109. Locking mechanism 108 selectively prevents axial translation of valve sleeve 90 within passage 62 and anti-rotation feature 109 includes a slot 110 that cooperates with pin 79 to prevent rotation of valve sleeve 90. That is, when valve sleeve 90 is acted upon to axially translate within passage 62, the interaction between pin(s) 79 and slots(s) 110 prevents rotation so as to ensure that the plurality of outlet portions 102 will align with plurality of outlets 66 when valve sleeve 90 is shifted in passage 62 as will be detailed herein.

In a non-limiting example, a first or shiftable valve seat 112 is arranged at first end 96 of valve sleeve 90 and a second or fixed valve seat 114 is arranged at second end 97 of valve sleeve 90. First valve seat 112 includes a first end section 117 and a second end section 118. An outer surface section 120 and an inner surface section 121 extend between first end section 117 and second end section 118. A plurality of passages 123 extend through first valve seat 117 at first end section 117. A plurality of detents 128 is arrayed about outer surface section 120 adjacent to plurality of passages 123. First end section 117 is also shown to include an angled edge 130.

In a non-limiting example, a plurality of shear elements 131 extends through corresponding ones of the plurality of passages 123, through first plurality of openings portions 104 in valve sleeve 90 and into annular groove 68. Shear elements 131 hold valve sleeve 90 in a position such that plurality of outlet portions 102 are not aligned with the plurality of outlets 66. In this manner, cementing valve 50 is maintained in a closed configuration. In a non-limiting example, a plurality of dogs 132 float in second plurality of opening portions 105 and rest on outer surface section 120 of first valve seat 112. A portion of each of the plurality of dogs 132 extends into annular recess 74.

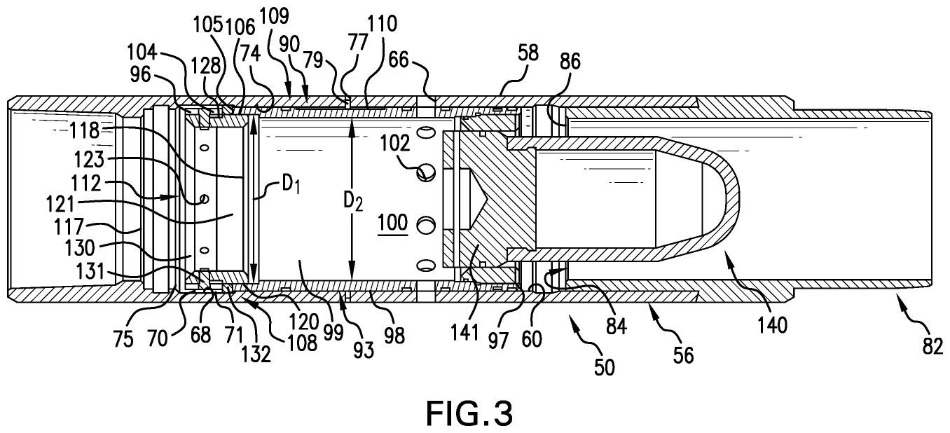

In a non-limiting example, prior to imitating a second phase of a cementing operation (e.g., forming another portion of liner 44 that unites with a liner portion pumped upwardly, a first dart 140 is introduced into tubular string 30 and allowed to fall or be pumped down to second valve seat 114. First dart 140 includes a landing portion 141 that rests in second valve seat 114 below plurality of outlet portions 102. Once landed, pressure may be applied causing shear elements 131 to fracture allowing valve sleeve 90 to shift in a down hole direction. While shifting, pin 79 in slot 110 constrains rotation of valve sleeve 90. Travel of valve sleeve 90 is limited by an interaction between dogs 132 and an axial end (not separately labeled) of annular recess 74 as shown in FIG. 3. At this point, plurality of outlet portions 102 are aligned with corresponding ones of the plurality of outlets 66 allowing cement to flow from tubular string 30 into wellbore 34 via cementing valve 50.

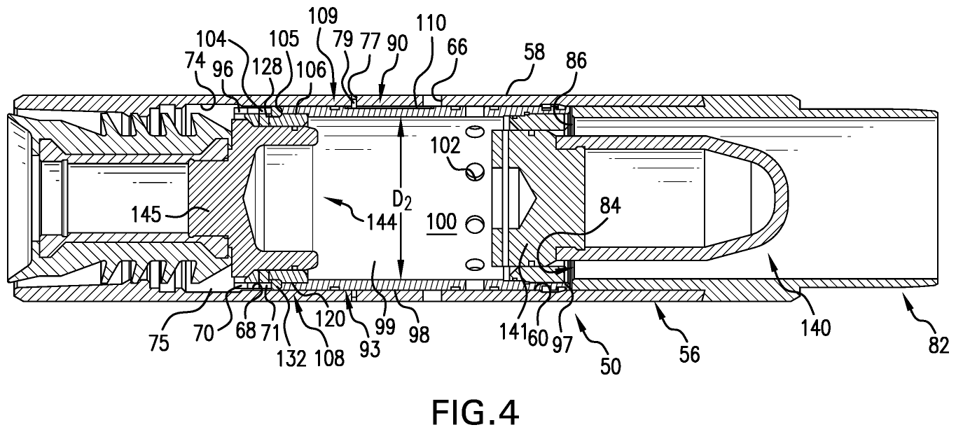

In a non-limiting example, once cementing is complete, a second dart 144 having a landing portion 145 is landed on angled edge 130 of first valve seat 112. Pressure is applied to second dart 144 once again causing shear elements 131 to fracture allowing first valve seat 112 to shift relative to valve sleeve 90. As first valve seat 112 shifts, detents 128 align with dogs 132. Dogs 132 drop into detents 128 releasing valve sleeve 90. In addition to allowing valve sleeve 90 to shift, dogs 132 dropping into corresponding ones of detents 128 also rotationally constrains first valve seat 112. Dogs 132 are held in detents 128 by outer surface 58 of housing 56. At this point, valve sleeve 90 may shift to misalign plurality or outlet portions 102 and plurality of outlets 66 to again position cementing valve 50 in a closed configuration such as shown in FIG. 4. Travel of valve sleeve 90 is arrested by travel limiter 86.

In a non-limiting example, once cementing valve 50 is closed, second dart 144, first dart 140 and portions of first valve seat 112 and second valve seat 114 may be drilled out to open a flow path from surface system 14 to toe 42. Cementing valve 50 may be drilled out to a diameter of D2 without unlocking first valve seat 112 from valve sleeve 90. That is, as dogs 132 do not extend into valve sleeve 90 beyond inner surface portion 99, second dart 114 can be drilled out to diameter D2 without releasing first valve seat 112 causing a spin out. That is, if first valve seat 112 releases from dogs 132 and rotates with the drill, opening tubular string 30 may be more challenging.

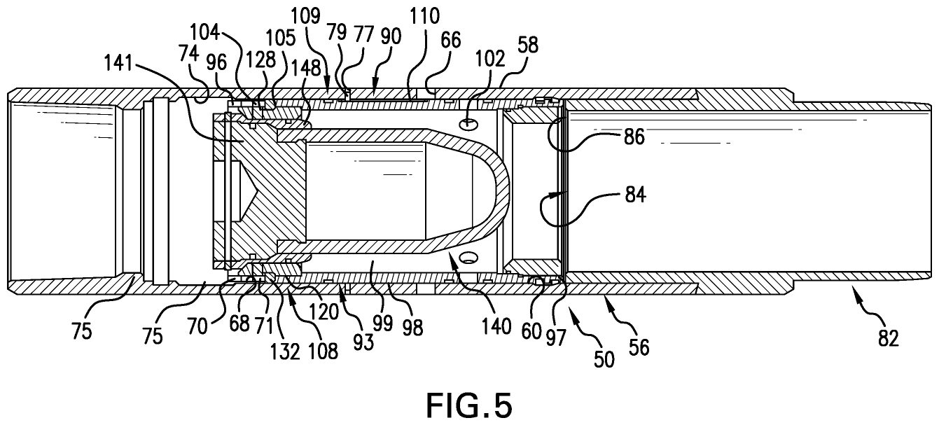

In a non-limiting example, if a second phase of cementing is not needed, a cancellation sleeve 148 may be installed on landing portion 141 of first dart 140 as shown in FIG. 5. Cancellation sleeve 148 increases an overall diameter of landing portion 141. In this manner, first dart 140 can land on first valve seat 112. Pressure may then be applied to dart 140 with cancellation sleeve 148 causing valve sleeve 90 to shift directly to the second closed configuration, bypassing the open configuration, prior to drill out. Modifying first dart 140 in this manner saves the time required to drop two darts to close cementing valve 50 prior to drill out.

Set forth below are some embodiments of the foregoing disclosure:

Embodiment 1. A wellbore tool comprising: a housing including a wall having an outer surface and an inner surface defining a passage, the housing having an outlet extending through the wall; a valve sleeve axially slidably arranged in the passage, the valve sleeve including a wall portion including a first end, a second end, an outer surface portion, an inner surface portion, an outlet portion that selectively aligns with the outlet in the housing; a locking mechanism provided on the valve sleeve; and a valve seat axially slidably arranged at the first end of the valve sleeve, the valve seat being selectively rotationally locked to the valve sleeve by the locking mechanism.

Embodiment 2. The wellbore tool according to any prior embodiment, wherein the locking mechanism includes a shear element extending through the valve seat, the valve sleeve and into the housing.

Embodiment 3. The wellbore tool according to any prior embodiment, further comprising: an annular groove formed on the inner surface spaced from the outlet in a first direction, wherein the shear element extends through into the annular groove.

Embodiment 4. The wellbore tool according to any prior embodiment, wherein the valve sleeve includes a first plurality of opening portions that selectively align with the annular groove, the shear element extending through one of the first plurality of opening portions into the annular groove.

Embodiment 5. The wellbore tool according to any prior embodiment, wherein the valve seat includes an outer surface section and an inner surface section, the outer surface section including a detent.

Embodiment 6. The wellbore tool according to any prior embodiment, wherein the valve sleeve includes a second plurality of opening portions arranged adjacent to the first plurality of opening portions, the locking mechanism includes a dog arranged in one of the second plurality of opening portions, the dog selectively extending into the detent to rotationally lock the valve seat relative to the valve sleeve.

Embodiment 7. The wellbore tool according to any prior embodiment, wherein the housing includes an annular recess arranged adjacent to the annular groove, the dog in the one of the second plurality of opening portions selectively extending into the annular recess.

Embodiment 8. The wellbore tool according to any prior embodiment, further comprising: another valve seat fixedly mounted to the inner surface of the valve sleeve at the second end.

Embodiment 9. The wellbore tool according to any prior embodiment, further comprising: a travel limiter arranged in the passage, the travel limiter constraining axial movement of the valve sleeve in the passage.

Embodiment 10. The wellbore tool according to any prior embodiment, further comprising: a slot formed in the outer surface portion of the valve sleeve, the slot extending between the first end and the second end; and a pin extending from the inner surface of the housing into the slot, the pin allowing axial translation of the valve sleeve in the passage and preventing rotational movement of the valve sleeve in the passage.

Embodiment 11. A resource exploration and recovery system comprising: a surface system; a subsurface system; and a tubular string extending from the surface system into the subsurface system, the tubular string supporting a wellbore tool comprising: a housing including a wall having an outer surface and an inner surface defining a passage, the housing having an outlet extending through the wall; a valve sleeve axially slidably arranged in the passage, the valve sleeve including a wall portion including a first end, a second end, an outer surface portion, an inner surface portion, an outlet portion that selectively aligns with the outlet in the housing; a locking mechanism provided on the valve sleeve; and a valve seat axially slidably arranged at the first end of the valve sleeve, the valve seat being selectively rotationally locked to the valve sleeve by the locking mechanism.

Embodiment 12. The resource exploration and recovery system according to any prior embodiment, wherein the locking mechanism includes a shear element extending through the valve seat, the valve sleeve and into the housing.

Embodiment 13. The resource exploration and recovery system according to any prior embodiment, further comprising: an annular groove formed on the inner surface spaced from the outlet in a first direction, wherein the shear element extends into the annular groove.

Embodiment 14. The resource exploration and recovery system according to any prior embodiment, wherein the valve sleeve includes a first plurality of opening portions that selectively align with the annular groove, the shear element extending through one of the first plurality of opening portions into the annular groove.

Embodiment 15. The resource exploration and recovery system according to any prior embodiment, wherein the valve seat includes an outer surface section and an inner surface section, the outer surface section including a detent.

Embodiment 16. The resource exploration and recovery system according to any prior embodiment, wherein the valve sleeve includes a second plurality of opening portions arranged adjacent to the first plurality of opening portions, the locking mechanism includes a dog arranged in one of the second plurality of opening portions, the dog selectively extending into the detent to rotationally lock the valve seat relative to the valve sleeve.

Embodiment 17. The resource exploration and recovery system according to any prior embodiment, wherein the housing includes an annular recess arranged adjacent to the annular groove, the dog in the one of the second plurality of opening portions selectively extending into the annular recess.

Embodiment 18. The resource exploration and recovery system according to any prior embodiment, further comprising: another valve seat fixedly mounted to the inner surface of the valve sleeve at the second end.

Embodiment 19. The resource exploration and recovery system according to any prior embodiment, further comprising: a travel limiter arranged in the passage, the travel limiter constraining axial movement of the valve sleeve in the passage.

Embodiment 20. The resource exploration and recovery system according to any prior embodiment, further comprising: a slot formed in the outer surface portion of the valve sleeve, the slot extending between the first end and the second end; and a pin extending from the inner surface of the housing into the slot, the pin allowing axial translation of the valve sleeve in the passage and preventing rotational movement of the valve sleeve in the passage.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A wellbore tool comprising:
a housing including a wall having an outer surface and an inner surface defining a passage, the housing having an outlet extending through the wall;
a valve sleeve axially slidably arranged in the passage, the valve sleeve including a wall portion including a first end, a second end, an outer surface portion, an inner surface portion, an outlet portion that selectively aligns with the outlet in the housing;
a locking mechanism provided on the valve sleeve; and
a valve seat axially slidably arranged at the first end of the valve sleeve, the valve seat being selectively rotationally locked to the valve sleeve by the locking mechanism.

2. The wellbore tool according to claim 1, wherein the locking mechanism includes a shear element extending through the valve seat, the valve sleeve and into the housing.

3. The wellbore tool according to claim 2, further comprising: an annular groove formed on the inner surface spaced from the outlet in a first direction, wherein the shear element extends through into the annular groove.

4. The wellbore tool according to claim 3, wherein the valve sleeve includes a first plurality of opening portions that selectively align with the annular groove, the shear element extending through one of the first plurality of opening portions into the annular groove.

5. The wellbore tool according to claim 4, wherein the valve seat includes an outer surface section and an inner surface section, the outer surface section including a detent.

6. The wellbore tool according to claim 5, wherein the valve sleeve includes a second plurality of opening portions arranged adjacent to the first plurality of opening portions, the locking mechanism includes a dog arranged in one of the second plurality of opening portions, the dog selectively extending into the detent to rotationally lock the valve seat relative to the valve sleeve.

7. The wellbore tool according to claim 6, wherein the housing includes an annular recess arranged adjacent to the annular groove, the dog in the one of the second plurality of opening portions selectively extending into the annular recess.

8. The wellbore tool according to claim 1, further comprising: another valve seat fixedly mounted to the inner surface of the valve sleeve at the second end.

9. The wellbore tool according to claim 1, further comprising: a travel limiter arranged in the passage, the travel limiter constraining axial movement of the valve sleeve in the passage.

10. The wellbore tool according to claim 1, further comprising:
a slot formed in the outer surface portion of the valve sleeve, the slot extending between the first end and the second end; and
a pin extending from the inner surface of the housing into the slot, the pin allowing axial translation of the valve sleeve in the passage and preventing rotational movement of the valve sleeve in the passage.

11. A resource exploration and recovery system comprising:
a surface system;
a subsurface system; and
a tubular string extending from the surface system into the subsurface system, the tubular string supporting a wellbore tool comprising:
a housing including a wall having an outer surface and an inner surface defining a passage, the housing having an outlet extending through the wall;
a valve sleeve axially slidably arranged in the passage, the valve sleeve including a wall portion including a first end, a second end, an outer surface portion, an inner surface portion, an outlet portion that selectively aligns with the outlet in the housing;
a locking mechanism provided on the valve sleeve; and
a valve seat axially slidably arranged at the first end of the valve sleeve, the valve seat being selectively rotationally locked to the valve sleeve by the locking mechanism.

12. The resource exploration and recovery system according to claim 11, wherein the locking mechanism includes a shear element extending through the valve seat, the valve sleeve and into the housing.

13. The resource exploration and recovery system according to claim 12, further comprising: an annular groove formed on the inner surface spaced from the outlet in a first direction, wherein the shear element extends into the annular groove.

14. The resource exploration and recovery system according to claim 13, wherein the valve sleeve includes a first plurality of opening portions that selectively align with the annular groove, the shear element extending through one of the first plurality of opening portions into the annular groove.

15. The resource exploration and recovery system according to claim 14, wherein the valve seat includes an outer surface section and an inner surface section, the outer surface section including a detent.

16. The resource exploration and recovery system according to claim 15, wherein the valve sleeve includes a second plurality of opening portions arranged adjacent to the first plurality of opening portions, the locking mechanism includes a dog arranged in one of the second plurality of opening portions, the dog selectively extending into the detent to rotationally lock the valve seat relative to the valve sleeve.

17. The resource exploration and recovery system according to claim 16, wherein the housing includes an annular recess arranged adjacent to the annular groove, the dog in the one of the second plurality of opening portions selectively extending into the annular recess.

18. The resource exploration and recovery system according to claim 11, further comprising: another valve seat fixedly mounted to the inner surface of the valve sleeve at the second end.

19. The resource exploration and recovery system according to claim 11, further comprising: a travel limiter arranged in the passage, the travel limiter constraining axial movement of the valve sleeve in the passage.

20. The resource exploration and recovery system according to claim 11, further comprising:
a slot formed in the outer surface portion of the valve sleeve, the slot extending between the first end and the second end; and
a pin extending from the inner surface of the housing into the slot, the pin allowing axial translation of the valve sleeve in the passage and preventing rotational movement of the valve sleeve in the passage.
